(19) United States
(12) Patent Application Publication
(10) Pub. No.: US 2026/0027868 A1
(43) Pub. Date: Jan. 29, 2026

(54) METHOD FOR AUTOMATICALLY STARTING UP OR SHUTTING DOWN VEHICLE-MOUNTED HUMIDIFIER

(71) Applicant: Guangzhou Issyzone Technology Co.,Limited, GUANGZHOU (CN)

(72) Inventors: Taiping Yang, Guangzhou (CN); Zegang Ye, Guangzhou (CN); Shuneng Huang, Guangzhou (CN)

(21) Appl. No.: 18/900,893

(22) Filed: Sep. 30, 2024

(30) Foreign Application Priority Data
Jul. 25, 2024 (CN) 2024110065449

(51) Int. Cl. B60H 1/00

(52) U.S. Cl. CPC B60H 1/00742; B60H 1/00785; B60H 1/00985

(57) ABSTRACT

The present invention discloses a method for automatically starting up or shutting down a vehicle-mounted humidifier, including the following steps: obtaining, at intervals, a vibration signal received by a humidifier, determining whether the vibration signal exceeds a preset vibration threshold, and if yes, generating a first control command, where the first control command is used to trigger an atomization module in the humidifier to start operating; and obtaining, at intervals, ambient humidity around the humidifier, determining whether the ambient humidity exceeds a preset humidity threshold, and if yes, generating a second control command, where the second control command is used to trigger the atomization module in the humidifier to stop operating. Benefits of the present invention are as follows: The vibration threshold is calibrated based on vibration frequency generated when a user sits in a driver's seat, which effectively reduces false startup of the atomization module.

### CROSS REFERENCE TO RELATED APPLICATIONS

The present application claims the priority of Chinese patent application No. 2024110065449, filed on Jul. 25, 2024, and contents of which are incorporated herein by reference.

### TECHNICAL FIELD

The present invention relates to the technical field of atomizers, and in particular, to a method for automatically starting up or shutting down a vehicle-mounted humidifier.

### TECHNICAL BACKGROUND

Vehicle-mounted humidifiers are common electronic products in vehicles, and switches of most existing vehicle-mounted humidifiers are controlled through buttons. However, users often forget to actively turn on the humidifiers, and the humidifiers still continue working after humidity in the vehicles exceeds a limit for comfort of the human body, which causes excessively high humidity in the vehicles.

Patent CN201597416U discloses a switch apparatus of a vehicle-mounted humidifier, a vibration sensor is connected in series to a power input end of a humidifier circuit, and the humidifier circuit is automatically turned on by sensing vibration of a vehicle body, to start up the humidifier without providing a switch additionally for manual operation; and a delay of about 35 s is set for the humidifier, and when the circuit works for more than 35 s, the circuit is instructed to stop working.

However, use scenarios of the vehicle-mounted humidifiers are very limited, there are a lot of battery electric vehicles on the market at present, and there is no engine vibration after the vehicles are started up. However, startup of the humidifiers is only triggered by vibration signals, trigger conditions of the sensors are calibrated based on amplitude of vehicle engines during startup, and therefore, after the battery electric vehicles are started up, the humidifiers are only started up when the vehicles reach uneven road sections, instead of being started up immediately. In addition, shutdown of the vehicle-mounted humidifiers is triggered by timing circuits, thereby failing to maintain the humidity in the vehicles at an expected value.

### SUMMARY

In view of the foregoing problems, the present invention proposes a method for automatically starting up or shutting down a vehicle-mounted humidifier, mainly intended to resolve the problems in Technical Background.

To resolve the foregoing technical problems, a technical solution of the present invention is as follows:

A method for automatically starting up or shutting down a vehicle-mounted humidifier, including the following steps:
obtaining, at intervals, a vibration signal received by a humidifier, determining whether the vibration signal exceeds a preset vibration threshold, and if yes, generating a first control command, where the first control command is used to trigger an atomization module in the humidifier to start operating, and the vibration threshold is calibrated based on vibration frequency generated when a user sits in a driver's seat; and
obtaining, at intervals, ambient humidity around the humidifier, determining whether the ambient humidity exceeds a preset humidity threshold, and if yes, generating a second control command, where the second control command is used to trigger the atomization module in the humidifier to stop operating.

In some embodiments, if a clock module starts timing after the atomization module switches from a shutdown state to a startup state, it is continuously detected whether the humidifier currently receives a shutdown command input manually within a first preset time range, and if yes, the vibration threshold is increased based on a preset value, the atomization module enters a silent state, and only a manually input startup command is allowed to trigger the startup of the atomization module.

In some embodiments, the atomization module in the shutdown state detects whether the humidifier currently receives a manually input startup command, and reduces the vibration threshold based on preset amplitude.

In some embodiments, it is detected whether the humidifier currently has an external power supply, and if yes, a state of charge of a built-in lithium battery is further detected, and the second control command is generated when the state of charge is lower than a preset value.

In some embodiments, if a clock module starts timing after the atomization module switches from the shutdown state to the startup state, it is continuously detected whether the humidifier currently receives a new vibration signal within a second preset time range, and if no, the second control command is generated.

In some embodiments, the atomization module in the startup state continuously detects a gesture input signal of the user, locally identifies a feature of the gesture input signal, and generates a fourth control command and a second control command based on the feature, where the fourth control command is used to control a volume of atomization output of the atomization module.

In some embodiments, after the fourth control command is generated, the ambient humidity is output to a display module at intervals of a set time, and after the set time expires, the next fourth control command is to be generated.

In some embodiments, the feedback voltage output by the atomization module is detected at intervals, and a duty cycle of a voltage input to the atomization module is negatively adjusted based on the feedback voltage.

In some embodiments, ambient illuminance around the humidifier is obtained at intervals, it is determined whether the ambient illuminance exceeds a preset illuminance threshold, and if yes, a festoon light mode of a humidifier light is started, or if no, a breathing light mode of the humidifier light is started.

In some embodiments, an externally input upgrade instruction is obtained, and the upgrade instruction includes at least a modified vibration threshold or humidity threshold.

Benefits of the present invention are as follows: The preset vibration threshold and humidity threshold are used as determining criteria, the vibration signal and the ambient humidity currently received by the humidifier are compared with the corresponding thresholds separately, and the corresponding control command is generated to trigger the startup or shutdown of the atomization module. The vibration threshold is calibrated based on the vibration frequency generated when the user sits in the driver's seat, which is different from amplitude-based triggering, thereby effectively reducing false startup of the atomization module. In addition, using the humidity threshold as an indicator of the shutdown also facilitates maintenance of the humidity in the vehicle.

### BRIEF DESCRIPTION OF THE DRAWINGS

FIG. 1 is a schematic flowchart of a method for automatically starting up or shutting down a vehicle-mounted humidifier disclosed in an embodiment of the present invention.

### DETAILED DESCRIPTION OF EMBODIMENTS

To make the purpose, the technical solution and the advantage of the present invention clearer and more explicit, content of the present invention is further described in detail below with reference to the accompanying drawings and embodiments. It should be understood that, the embodiments described here are only intended to explain the present invention rather than limit the present invention. In addition, it should also be noted that, for ease of description, only some contents related to the present invention other than all the contents are shown in the drawings.

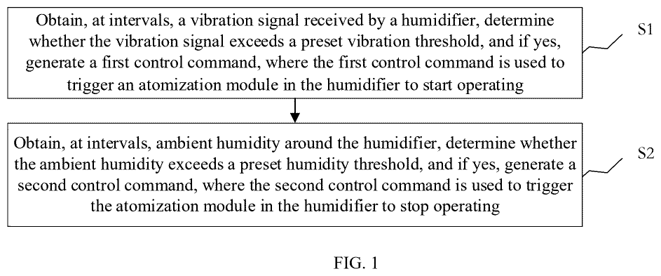

As shown in FIG. 1, this embodiment proposes a method for automatically starting up or shutting down a vehicle-mounted humidifier, including the following steps:
S1. Obtain, at intervals, a vibration signal received by a humidifier, determine whether the vibration signal exceeds a preset vibration threshold, and if yes, generate a first control command, where the first control command is used to trigger an atomization module in the humidifier to start operating, and the vibration threshold is calibrated based on vibration frequency generated when a user sits in a driver's seat.
S2. Obtain, at intervals, ambient humidity around the humidifier, determine whether the ambient humidity exceeds a preset humidity threshold, and if yes, generate a second control command, where the second control command is used to trigger the atomization module in the humidifier to stop operating.

In this embodiment, the preset vibration threshold and humidity threshold are used as determining criteria, the vibration signal and the ambient humidity currently received by the humidifier are compared with the corresponding thresholds separately, and the corresponding control command is generated to trigger the startup or shutdown of the atomization module. The vibration threshold is calibrated based on the vibration frequency generated when the user sits in the driver's seat, which is different from amplitude-based triggering, thereby effectively reducing false startup of the atomization module. In addition, using the humidity threshold as an indicator of the shutdown also facilitates maintenance of the humidity in the vehicle.

Further, the foregoing vibration frequency refers to vibration frequency generated at a moment when the human body comes into contact with the seat after the user sits in the driver's seat, and 50% of the vibration frequency is generally selected as the vibration threshold. During calibration, technicians need to obtain, through simulation, vibration frequency of multiple mainstream seats generated at moments when the user comes into contact with the seats. In general, the vibration frequency generated when the engine is started up is higher, and it is assumed that after the engine is started up, the startup of the atomization module can also be triggered.

In some non-driving scenarios, if the user currently opens a vehicle door but does not enter the vehicle, opening or closing the vehicle door causes large vibration at this moment, and if the atomization module is falsely started up, power is consumed meaninglessly. To further reduce the false startup of the atomization module, as another preferred solution of step S1, the method also includes step S3. S3. If a clock module starts timing after the atomization module switches from a shutdown state to a startup state, continuously detect whether the humidifier currently receives a shutdown command input manually within a first preset time range, and if yes, increase the vibration threshold based on a preset value, where the atomization module enters a silent state, and only a manually input startup command is allowed to trigger the startup of the atomization module.

In the foregoing solution, after the user enters the vehicle normally and the atomization module is started up, the user usually does not choose to actively turn off the humidifier immediately. Assuming that only the vibration frequency generated when the user opens the vehicle door currently causes the startup of the atomization module (there is usually a conspicuous light prompt after the startup), the user can manually turn off the humidifier within the first preset time range (which can be set to 3 to 5 seconds) (if the user does not manually turn off the humidifier within the time range, the startup is considered to be normal). In this case, such trigger condition can be determined to be excessively sensitive, and a background program of the humidifier can increase the vibration threshold by about 3%, but the vibration threshold cannot exceed the vibration frequency selected during calibration. Then the atomization module enters a silent state. To avoid restart of the atomization module when the user closes the vehicle door, only a manually input boot command is allowed to trigger the startup of the atomization module.
S4. The atomization module in the shutdown state detects whether the humidifier currently receives a manually input startup command, and reduces the vibration threshold based on preset amplitude. If the atomization module is still in the shutdown state after the user enters the vehicle, the trigger condition is considered to be excessively sluggish, and the background program of the humidifier can reduce the vibration threshold by about 3%.
S5. Detect whether the humidifier currently has an external power supply, and if yes, further detect a state of charge of a built-in lithium battery, and generate the second control command when the state of charge is lower than a preset value, to instruct the atomization module to stop operating, where the system enters a low-power consumption state.
S6. If the clock module starts timing after the atomization module switches from the shutdown state to the startup state, continuously detect whether the humidifier currently receives a new vibration signal within a second preset time range, and if no, generate the second control command, to instruct the atomization module to stop operating. Step S6 is another important supplement to step S1. When the user is out of the vehicle for a period of time, no new vibration signal is subsequently generated, and therefore, the atomization module is instructed to stop operating, and the system enters the low-power consumption state.
S7. The atomization module in the startup state continuously detects a gesture input signal of the user, locally identifies a feature of the gesture input signal, and generates a fourth control command and a second control command based on the feature, where the fourth control command is used to control a volume of atomization output of the atomization module. In an example, features of gesture input signals can be divided into horizontal movement and vertical movement. For example, if a currently identified gesture input signal indicates rightward movement or leftward movement, the fourth control command is generated to increase or decrease the volume of atomization; and if a currently identified gesture input signal indicates downward movement or upward movement, the second control command is generated to turn off the atomization module.

In addition to step S7, the method further includes step S8. S8. After the fourth control command is generated, output the ambient humidity to a display module at intervals of a set time, so that the display module displays current ambient humidity for the user; and after the set time expires, generate the next fourth control command.
S9. Detect the feedback voltage output by the atomization module at intervals, and negatively adjust a duty cycle of a voltage input to the atomization module based on the feedback voltage. In this optional solution, the control module detects the feedback voltage output by the atomization module, negatively adjusts voltage excitation applied to the atomization module after calculation, and controls power of the atomization module within a certain range, to maintain a volume of spray of the atomization module.

Optionally, the method further includes step S10. S10. Obtain ambient illuminance around the humidifier at intervals, determine whether the ambient illuminance exceeds a preset illuminance threshold, and if yes, start a festoon light mode of a humidifier light, or if no, start a breathing light mode of the humidifier light.

Optionally, the method further includes step S11. S11. Obtain an externally input upgrade instruction, where the upgrade instruction includes at least a modified vibration threshold or humidity threshold.

Unless otherwise specified actively, the foregoing steps S1 to S11 are not performed in a specific sequence.

The foregoing embodiments are only intended to illustrate a technical idea and characteristics of the present invention, so that persons of ordinary skills in the art can understand content of the present invention and implement it accordingly, and the protection scope of the present invention is not limited thereto. Any equivalent changes or modifications made according to substance of the content of the present invention shall fall within the protection scope of the present invention.

In addition, using the humidity threshold as an indicator of the shutdown also facilitates maintenance of humidity in a vehicle.

1. A method for automatically starting up or shutting down a vehicle-mounted humidifier, comprising the following steps:
obtaining, at intervals, a vibration signal received by a humidifier, determining whether the vibration signal exceeds a preset vibration threshold, and if yes, generating a first control command, wherein the first control command is used to trigger an atomization module in the humidifier to start operating, and the vibration threshold is calibrated based on vibration frequency generated when a user sits in a driver's seat; and
obtaining, at intervals, ambient humidity around the humidifier, determining whether the ambient humidity exceeds a preset humidity threshold, and if yes, generating a second control command, wherein the second control command is used to trigger the atomization module in the humidifier to stop operating.

2. The method for automatically starting up or shutting down a vehicle-mounted humidifier according to claim 1, wherein if a clock module starts timing after the atomization module switches from a shutdown state to a startup state, it is continuously detected whether the humidifier currently receives a shutdown command input manually within a first preset time range, and if yes, the vibration threshold is increased based on a preset value, the atomization module enters a silent state, and only a manually input startup command is allowed to trigger the startup of the atomization module.

3. The method for automatically starting up or shutting down a vehicle-mounted humidifier according to claim 1, wherein the atomization module in the shutdown state detects whether the humidifier currently receives a manually input startup command, and reduces the vibration threshold based on preset amplitude.

4. The method for automatically starting up or shutting down a vehicle-mounted humidifier according to claim 1, wherein it is detected whether the humidifier currently has an external power supply, and if yes, a state of charge of a built-in lithium battery is further detected, and the second control command is generated when the state of charge is lower than a preset value.

5. The method for automatically starting up or shutting down a vehicle-mounted humidifier according to claim 1, wherein if a clock module starts timing after the atomization module switches from the shutdown state to the startup state, it is continuously detected whether the humidifier currently receives a new vibration signal within a second preset time range, and if no, the second control command is generated.

6. The method for automatically starting up or shutting down a vehicle-mounted humidifier according to claim 1, wherein the atomization module in the startup state continuously detects a gesture input signal of the user, locally identifies a feature of the gesture input signal, and generates a fourth control command and a second control command based on the feature, wherein the fourth control command is used to control a volume of atomization output of the atomization module.

7. The method for automatically starting up or shutting down a vehicle-mounted humidifier according to claim 6, wherein after the fourth control command is generated, the ambient humidity is output to a display module at intervals of a set time, and after the set time expires, the next fourth control command is to be generated.

8. The method for automatically starting up or shutting down a vehicle-mounted humidifier according to claim 1, wherein the feedback voltage output by the atomization module is detected at intervals, and a duty cycle of a voltage input to the atomization module is negatively adjusted based on the feedback voltage.

9. The method for automatically starting up or shutting down a vehicle-mounted humidifier according to claim 1, wherein ambient illuminance around the humidifier is obtained at intervals, it is determined whether the ambient illuminance exceeds a preset illuminance threshold, and if yes, a festoon light mode of a humidifier light is started, or if no, a breathing light mode of the humidifier light is started.

10. The method for automatically starting up or shutting down a vehicle-mounted humidifier according to claim 1, wherein an externally input upgrade instruction is obtained, and the upgrade instruction comprises at least a modified vibration threshold or humidity threshold.
